(19) United States
(12) Patent Application Publication
(10) Pub. No.: US 2014/0365926 A1
(43) Pub. Date: Dec. 11, 2014

(54) APPARATUS AND METHOD FOR PROVIDING GRAPHIC EDITORS

(71) Applicant: Electronics and Telecommunications Research Institute, Daejeon (KR)

(72) Inventor: Young-Hwan BAE, Daejeon (KR)

(21) Appl. No.: 14/297,278

(22) Filed: Jun. 5, 2014

(30) Foreign Application Priority Data
Jun. 5, 2013 (KR) 10-2013-0064526

(51) Int. Cl. G06T 11/20; G06T 3/40; G06F 3/0484

(52) U.S. Cl. CPC G06T 11/20; G06F 3/04842; G06T 3/40; G06T 2200/24; G06T 2215/16
USPC 715/763

(57) ABSTRACT

A method and apparatus for providing graphic editors are disclosed. The apparatus includes a coordinate system setting unit, a windowing unit, a window definition unit, a window manager unit, a graphics object setting unit, and an event processing unit. The coordinate system setting unit sets a coordinate system as a real-world coordinate system. The windowing unit converts figures within a data structure into coordinates of a window coordinate system. The window definition unit defines a pair of one view region and a real physical window as one virtual canvas window. The window manager unit converts coordinates of the virtual canvas window into window coordinates. The graphics object setting unit sets graphics objects corresponding to the data structure of the figures. The event processing unit provides a graphic editor so that an event is processed using the graphics characteristics and the graphics objects.

### CROSS REFERENCE TO RELATED APPLICATION

This application claims the benefit of Korean Patent Application No. 10-2013-0064526, filed on Jun. 5, 2013, which is hereby incorporated by reference in its entirety into this application.

### BACKGROUND OF THE INVENTION

1. Technical Field

The present invention relates generally to an apparatus and method for providing graphic editors and, more particularly, to an apparatus and method for providing graphic editors, which are capable of providing a variety of graphic editors.

2. Description of the Related Art

A Graphical User Interface (GUI) is a means for enabling information to be most efficiently exchanged between humans and a computer. Such GUIs have rapidly developed along with computers.

Recently, under a UNIX operating system, the X Window System using a client-server method over a network has become a worldwide standard for window graphics. Furthermore, graphics libraries (e.g., the X Library and Motif) provide high-level functions, thereby facilitating the development of a graphics tool.

Despite such an advantage, when a Computer Aided Design (CAD) graphic editor using two-dimensional graphics is developed, figure coordinate system conversion, windowing and input event processing functions need to be additionally programmed.

An apparatus for providing graphic editors is a library-type package in which only common functions required for all graphic editors in the field of CAD have been collected and implemented. The apparatus provides a GUI window, and provides the functions of performing figure drawing, coordinate conversion, windowing, and input event processing.

These functions are common to most of graphic editors, and are parts that are repeated whenever a graphics program is developed. There is a need for technology capable of organizing these functions into a library.

### SUMMARY OF THE INVENTION

Accordingly, the present invention has been made keeping in mind the above problems occurring in the conventional art, and an apparatus and method for providing graphic editors, which are capable of providing a variety of graphic editors.

In accordance with an aspect of the present invention, there is provided a method of providing graphic editors, including setting, by an apparatus for providing graphic editors, a coordinate system, which will be applied to a task of outputting one or more figures within a data structure onto a screen, as a real-world coordinate system; converting the figures within the data structure, stored in the real-world coordinate system, into coordinates of a window coordinate system; defining a pair of one view region in the real-world coordinate system and a real physical window in which the one view region is output onto a screen, as a single virtual canvas window; converting the virtual canvas window into window coordinates on the screen using the window coordinate system, and designating graphics characteristics for the output task; setting graphics objects corresponding to the data structure of the figures defined to draw a graphics figure in the virtual canvas window; and providing a graphic editor so that an event corresponding to input data received from a user is processed using the graphics characteristics and the graphics objects.

Setting the coordinate system as the real-world coordinate system may include setting the coordinate system as an X-Y rectangular coordinate system.

Converting the figures within the data structure into the coordinates of the window coordinate system may include performing windowing adapted to execute tasks including a screen enlargement command, a screen reduction command, and a screen movement command.

Defining the virtual canvas window may include defining a virtual window in which the figures are drawn using real real-world coordinates of the figures stored in the data structure without the conversion of coordinates.

Designating the graphics characteristics may include designating graphics characteristics corresponding to the figures so that the figures are finally drawn in a window on a screen using output-related functions provided by a Window System.

A command function of the output-related functions may correspond to a function required to convert the coordinates of the virtual canvas window into the window coordinates on the screen.

In accordance with another aspect of the present invention, there is provided an apparatus for providing graphic editors, including a coordinate system setting unit configured to set a coordinate system, which will be applied to the task of outputting figures within a data structure to a screen, as a real-world coordinate system; a windowing unit configured to convert the figures within the data structure, stored in the real-world coordinate system, into coordinates of a window coordinate system; a window definition unit configured to define a pair of one view region in the real-world coordinate system and a real physical window in which the one view region is output onto a screen as one virtual canvas window; a window manager unit configured to convert coordinates of the virtual canvas window into window coordinates on the screen using the window coordinate system and to designate graphics characteristics for the output task; a graphics object setting unit configured to set graphics objects corresponding to the data structure of the figures defined to draw a graphics figure in the virtual canvas window; and an event processing unit configured to provide a graphic editor so that an event corresponding to input data received from a user is processed using the graphics characteristics and the graphics objects.

The coordinates setting unit may set the coordinate system as an X-Y rectangular coordinate system corresponding to the real-world coordinate system.

The windowing unit may convert the figures into coordinates of the window coordinate system through windowing adapted to execute tasks including a screen enlargement command, a screen reduction command, and a screen movement command.

The window definition unit may define a virtual window in which the figures are drawn using real-world coordinates of the figures stored in the data structure without the conversion of coordinates.

The window manager unit may designate graphics characteristics corresponding to the figures so that the figures are finally drawn in a window on a screen using output-related functions provided by a Window System.

A command function of the output-related functions may correspond to a function required to convert the coordinates of the virtual canvas window into the window coordinates on the screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a basic graphical user interface window for an apparatus for providing graphic editors;

FIG. 2 is a diagram illustrating the structure of a graphic editor according to an embodiment of the present invention;

FIG. 3 is a diagram schematically illustrating the configuration of an apparatus for providing graphic editors according to an embodiment of the present invention;

FIG. 4 is a diagram illustrating a virtual canvas manager and a coordinate system according to an embodiment of the present invention;

FIG. 5 is a diagram illustrating basic figures represented by graphics objects according to an embodiment of the present invention;

FIG. 6 is a diagram illustrating the graphics characteristics of the basic figures according to an embodiment of the present invention;

FIG. 7 is a diagram illustrating an input manager unit according to an embodiment of the present invention;

FIG. 8 is a diagram illustrating the structure of command functions according to an embodiment of the present invention;

FIG. 9 is a flowchart illustrating a method of providing graphic editors according to an embodiment of the present invention;

FIG. 10 is a diagram illustrating the structure of an apparatus for providing graphic editors according to an embodiment of the present invention; and

FIG. 11 is a diagram illustrating the class structure of an apparatus for providing graphic editors according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

An apparatus and method for providing graphic editors according to embodiments of the present invention are described in detail below with reference to the accompanying drawings.

An apparatus for providing graphic editors according to an embodiment of the present invention implements common functions required for graphic editors and organizes them into a library. That is, the apparatus for providing graphic editors corresponds to an apparatus for providing a library-type package in which only common functions required for all the graphic editors in the field of semiconductor CAD have been collected and implemented.

The apparatus for providing graphic editors has the following functions.

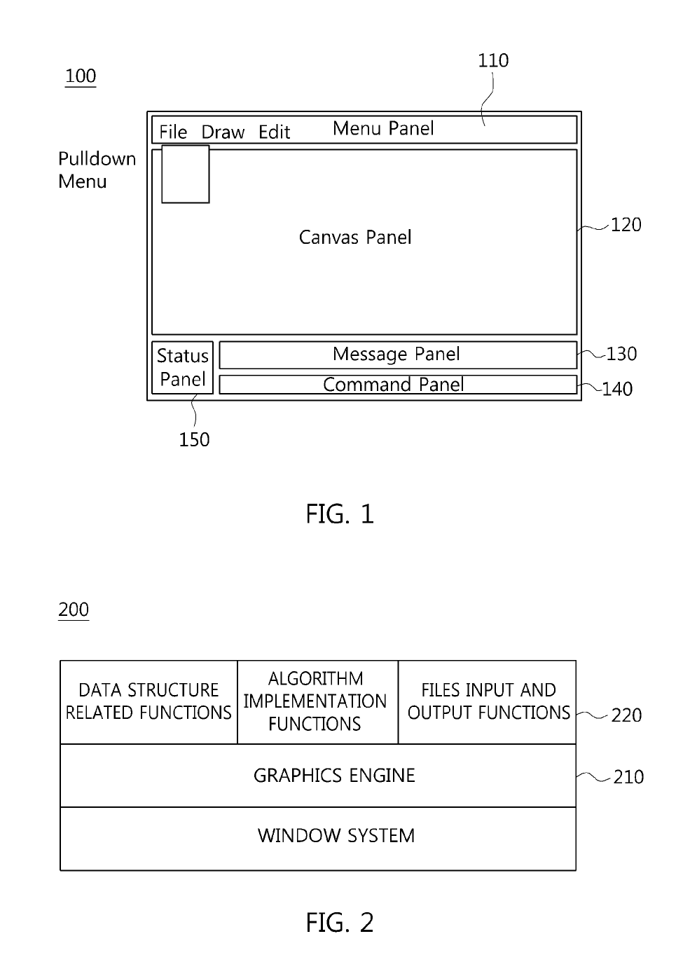

First, the apparatus for providing graphic editors provides a basic GUI window 100 that is required for graphic editors, as illustrated in FIG. 1, and performs functions, such as figure drawing, coordinate conversion, windowing, and input event processing.

The GUI window 100 includes a menu panel 110, a canvas panel 120, a message panel 130, a command panel 140, and a status panel 150.

The menu panel 110 is placed at the upper end of the GUI window 100, and includes a pulldown menu of commands that are defined by an application programmer.

The canvas panel 120 is a region in which the task of editing a figure is performed. Functions, such as figure drawing, event processing, coordinate conversion, and windowing, are performed in the canvas panel 120.

The message panel 130 is a region in which a message to be delivered to a user is displayed during the execution of a program applied to the editing of graphics.

The command panel 140 delivers a character string, input by a user using an input device, such as a keyboard, to a function designated by an application programmer, and then processes the character string.

Various parameters are provided so that the GUI window 100 provided by the apparatus for providing graphic editors according to an embodiment of the present invention may be modified depending on the purpose of an application. In some cases, a GUI directly programmed by an application programmer may also be registered.

Second, the apparatus for providing graphic editors provides overall functions that are required to draw a figure in the GUI window 100.

For example, if a figure is drawn using the X Library of graphics libraries, graphics characteristics, such as the color of the figure, a filling pattern, and the thickness and type of a line, need to designated, the data of the figure stored in the data structure of an application in the form of real-world coordinates needs to be converted into window coordinates, and the function of the X Library that will output the figure to be drawn needs to be fetched.

The apparatus for providing graphic editors provides a function for automatically processing a series of processes that are performed when a figure is drawn using the X Library. That is, if only the data and type of a figure within a data structure stored in the form of real-world coordinates are delivered to a drawing function, the apparatus for providing graphic editors performs the above-described process. Furthermore, since windowing commands, such as zoom in/out, pan, and fit, have been implemented in the apparatus for providing graphic editors, an application programmer does not need to separately implement the windowing commands only if the windowing commands are connected to the drawing function. The apparatus for providing graphic editors may display all figures within the same data structure in multiple windows at the same time and edit the figures because it basically supports a multi-window environment. Each of the windows is independently windowed, and the results of edition in one window are automatically applied to another window.

Third, the apparatus for providing graphic editors collects input events generated by a user or a Window System, selects only events required to perform commands, and delivers the selected events to command functions. Accordingly, an application programmer does not need to become aware of the complicated event structure of the X Window System. The apparatus for providing graphic editors automatically processes basic window events, that is, events that are generated by an overlap between windows and changes in size and position, and draws a figure displayed on a window again. Furthermore, the apparatus for providing graphic editors basically provides various types of rubberbands that assist in editing a figure.

Fourth, the apparatus for providing graphic editors provides a framework that is required to provide a graphic editor. Basic frames have been completed in the apparatus for providing graphic editors so that an application programmer can generate modules already implemented in the apparatus for providing graphic editors and configures the entire system using the modules. Since each partial module is one independent object, an environment in which CAD graphic editors have been integrated may be constructed using the modules.

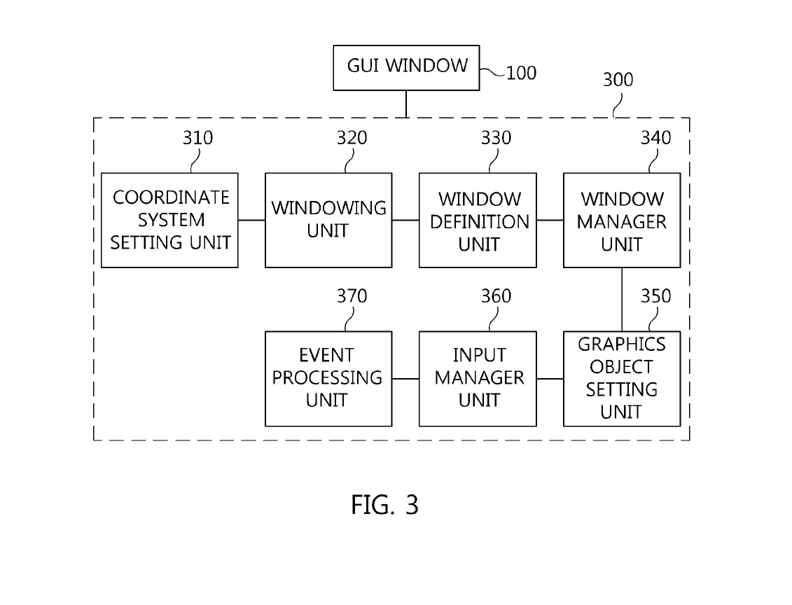

A graphic editor provided by the apparatus for providing graphic editors is described in detail below with reference to FIG. 2.

FIG. 2 is a diagram illustrating the structure of a graphic editor according to an embodiment of the present invention.

Referring to FIG. 2, the graphic editor includes a graphics engine part 210 configured to perform functions related to graphics and an application part 220 configured to implement the algorithms of applications.

The application part 220 includes functions related to a data structure configured to perform functions suitable for applications, functions configured to implement algorithms, and functions configured to input and output files.

Multiple object classes configured to perform functions required to implement a graphic editor are defined in the apparatus for providing graphic editors. Accordingly, in the stage of implementing an application, it is sufficient if required objects are generated, characteristics suitable for a purpose are designated, and connections are made so that the objects can exchange required data.

The apparatus for providing graphic editors is described in detail with reference to FIG. 3.

FIG. 3 is a diagram schematically illustrating the configuration of an apparatus 300 for providing graphic editors according to an embodiment of the present invention.

Referring to FIG. 3, the apparatus 300 for providing graphic editors includes a coordinate system setting unit 310, a windowing unit 320, a window definition unit 330, a window manager unit 340, a graphics object setting unit 350, an input manager unit 360, and an event processing unit 370. Furthermore, the apparatus 300 for providing graphic editors operates in conjunction with a GUI window 100.

The coordinate system setting unit 310 sets a coordinate system, which is required for the task of outputting a specific figure within a data structure to a screen, as a real-world coordinate system.

A graphic editor is a program that enables a task, which is performed in the real world, to be performed using limited resources, that is, a computer, and thus requires a coordinate system capable of representing a figure. Furthermore, the task of outputting a figure onto the screen of a computer needs to be accompanied by a coordinate system conversion task.

All drawing tasks in computer graphics are performed based on screen coordinates on a computer screen. A screen coordinate system is used on a computer monitor screen, and is a rectangular coordinate system in which a top left point on a screen is an origin and the resolution value of the screen is a maximum value in the direction of each of X and Y axes. All figures to be drawn by a user are converted into screen coordinates, the results of the conversion are copied to memory called a frame buffer within the computer, and the copied results are displayed on a screen.

In a Window System, a window coordinate system is used instead of a screen coordinate system.

The window coordinate system is a rectangular coordinate system in which a top left point n on a window is an origin and the width and height of the window have maximum values in the direction of each of X and Y axes. A figure drawn based on the window coordinate system is automatically converted into screen coordinates within the Window System, and is then output.

In such screen and window coordinate systems, it is difficult to represent a real-world figure using the coordinate systems because a maximum value of a coordinate value is limited by the size of a screen or a window.

Accordingly, in all the graphics application fields, another coordinate system capable of representing the real world is introduced and used, which is a real-world coordinate system.

The real-world coordinate system is an X-Y rectangular coordinate system, and has a range from − infinity to + infinity in each of the X and Y axes. In general, however, if the real-world coordinate system is stored in memory within a computer, when X and Y coordinates are stored using 32-bit integers, the real-world coordinate system has a range from −2,147,483,648 to +2,147,483,648. Accordingly, in order to represent a figure within a data structure, stored as real-world coordinates on a screen, as a figure, there is a need for the task of converting the real-world coordinates into the coordinates of a screen or window coordinate system.

The windowing unit 320 converts a figure within a data structure, stored as a real-world coordinate system set by the coordinate system setting unit 310, into a screen or window coordinate system.

Referring to FIG. 3, if it is difficult to represent all figures in a real-world coordinate system on a screen, the windowing unit 320 defines a rectangular region, which will be represented as a figure in the real-world coordinate system, as a single view region, converts only figures within the defined view region into a screen or window coordinate system, and draws the figures on a screen.

For example, a view region of FIG. 3 includes a schematic view including data regarding a circuit diagram, and a layout view including data regarding a semiconductor chip layout.

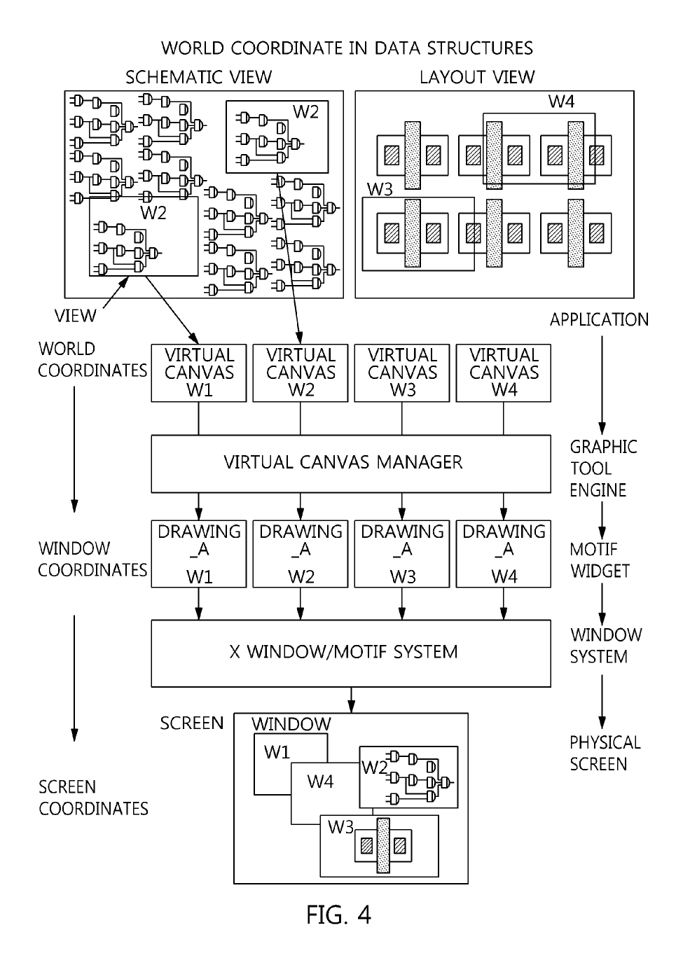

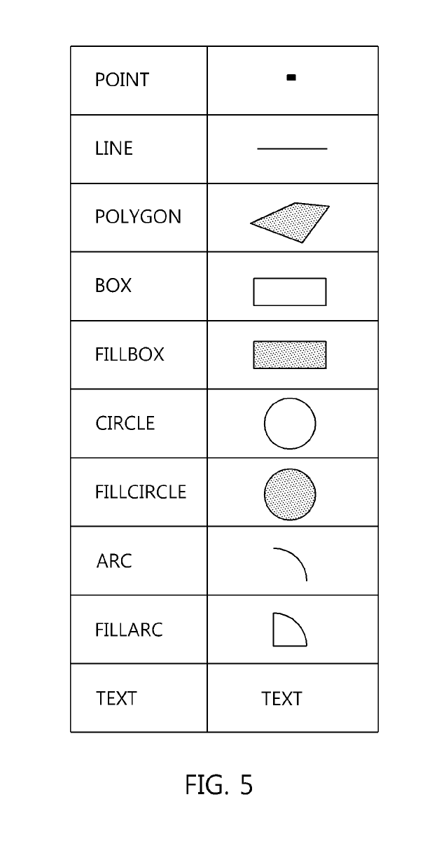

A user selects rectangular regions (e.g., a virtual canvas W1 to a virtual canvas W4 in FIG. 4), which will be displayed as a figure in a real-world coordinate system, from the view region.

In a Window System that supports multiple windows, a plurality of view regions may be present in the same real-world coordinate system, and the corresponding task of converting a coordinate system and a physical window onto which a figure will be output need to be separate for each of the view regions. The position and size of such a view region needs to vary in a real-world coordinate system, if necessary.

The windowing unit 320 defines the process of converting a figure into the coordinates of a screen or window coordinate system, as described above, as windowing. Windowing is a command that execute tasks, such as a zoom-in command, a zoom-out command, a pan command, and a fit command.

The window definition unit 330 defines a pair of a view region in a real-world coordinate system and a real physical window in which the view region is actually output onto a screen as a virtual canvas window. In this case, the virtual canvas window is a virtual window that enables figures to be drawn in the form of real-world coordinates stored in a data structure without the conversion of coordinates.

A real coordinate conversion task is performed by the window manager unit 340, and is output to the physical window of a screen which is associated with a virtual canvas window.

The window manager unit 340 corresponds to a virtual canvas manager, and provides a series of windowing tasks related to coordinate conversion and general means required to draw a graphics figure for multiple virtual canvas windows that are managed by the window manager unit 340.

All graphics applications transfer graphics figures, represented as real-world coordinates as illustrated in FIG. 4, and virtual canvas windows W1 to W4 in which the figures will be output to the virtual canvas manager, that is, the window manager unit 340, without requiring separate complicated coordinate conversion.

The window manager unit 340 converts the coordinates of a virtual canvas window into the coordinates of a window on a real screen, designates graphics characteristics for an output task, and finally draws a figure in the window on the screen using output-related functions provided by a Window System.

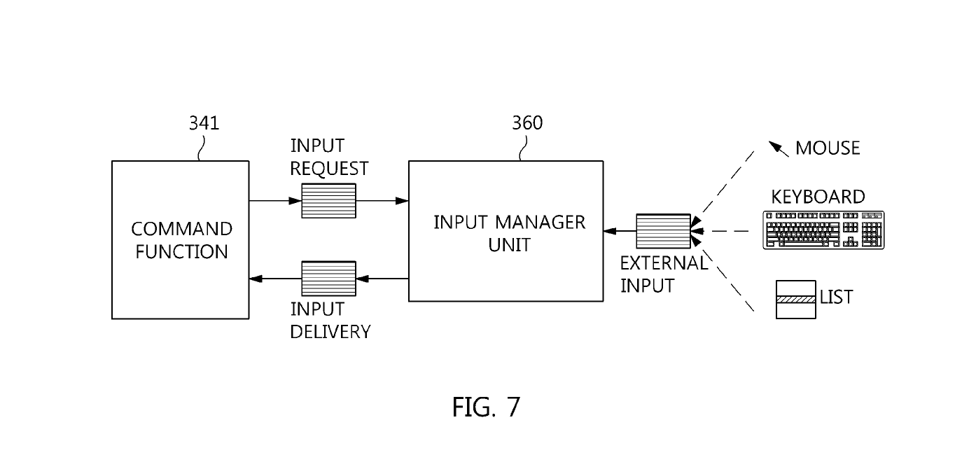

The window manager unit 340 includes at least one command function 341 (see FIG. 7) that performs windowing.

The graphics object setting unit 350 is the data structure of figures that are defined to draw a graphics figure in a virtual canvas window, and sets a graphics object corresponding to a data format in which the type and characteristics of a figure to be output onto a screen are transferred to a virtual canvas window. In this case, the graphics object represents all figures and the characteristics of the figures that may be output via the X Library.

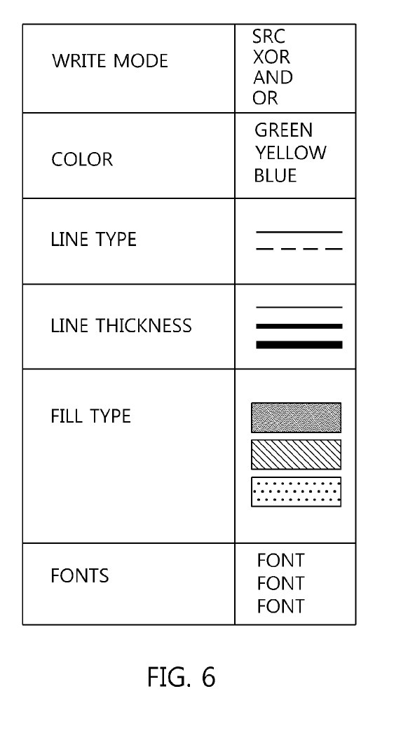

Basic figures represented by graphics objects are illustrated in FIG. 5, and the graphics characteristics of the basic figures are illustrated in FIG. 6.

Referring to FIG. 5, the basic figures include a point, a line, a polygon, a box, a fillbox, a circle, a fillcircle, an arc, a fillarc, and text.

Referring to FIG. 6, the graphics characteristics of the basic figures include write mode, color, line type, line thickness, fill type, and fonts.

That is, a graphics object is the data structure of a figure that is output onto a screen. Graphics data having information related to a figure is inside a graphics object, and a graphics characteristic part defining the characteristics of graphics output is above the graphics data.

Graphics objects according to this embodiment of the present invention have been designed by sufficiently considering the extensibility of an application programmer. For example, figures, such as a line, a box, a circle and an arc, are defined as basic graphics objects within the apparatus for providing graphic editors. If an application programmer defines a figure (e.g., a symbol or an input/output terminal), configured using two or more basic figures in a composite manner, as a new graphics object and adds the new graphics object, the new figure may also be drawn using the same figure drawing command as the basic figures.

The input manager unit 360 receives input data from at least one input source, and delivers the received input data to the command function 341 through a single path.

In general, input from a user outside hardware is limited to the coordinates of a point input by a mouse, the state of the button of the mouse, and a character string input by a keyboard. In contrast, a graphics program executed in a Window System may be combined with various user interface tools and delivered via various types of paths.

For example, if it is desired to input a character string, the character string may be input by selecting one item of the menu or selection window of a Motif tool kit using a mouse. A character string may be input in a text window via a keyboard.

Referring to FIG. 7, the input manager unit 360 receives an input request from the command function 341, and receives input data, corresponding to the input request, from the outside. In this case, the input manager unit 360 receives the external input through one input source selected from among a mouse, a keyboard and text.

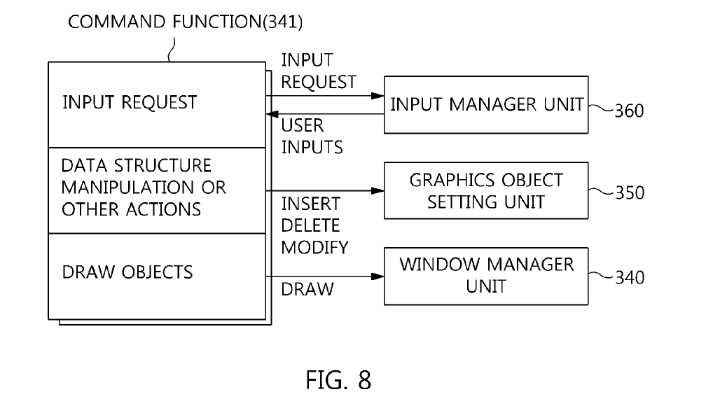

Referring to FIG. 8, the input manager unit 360 delivers input data (i.e., user inputs), received from the outside, to the command function 341 (input delivery). The command function 341 performs a command related to windowing, and may request a desired input form from the input manager unit 360.

Referring to FIG. 8, the command function 341 includes an input request, data structure manipulation or other actions, and draw objects.

The graphics object setting unit 350 is the data structure of figures that is defined to draw a graphics figure in a virtual canvas window, and sets a graphics object corresponding to a data format in which the type and characteristics of a figure to be output onto a screen are delivered to a virtual canvas window.

If an event that belongs to externally received inputs and corresponds to input desired by the command function 341 is received, the input manager unit 360 delivers the received input to the command function 341.

The event processing unit 370 processes the events of all users which occur in a window on a screen, and delivers data, corresponding to the event of a user, to the command function 341 via the input manager unit 360.

If an event is received from a Window System and the received event corresponds to a rubberband drawing request, the event processing unit 370 delivers the event to the window manager unit 340 so that the window manager unit 340 draws rubberband. If an event is an event whose input has been requested by the command function 341, the window manager unit 340 delivers the event to the command function 341 via the input manager unit 360.

If an event does not correspond to any of the two events, the event is processed by the event processing unit 370. Such an event may include, for example, a window exposure event and a window size change event.

A canvas window is drawn again in response to the window exposure event. The window manager unit 340 is fetched in response to the window size change event so that the window manager unit 340 newly calculates the size of a corresponding canvas window and refreshes the window.

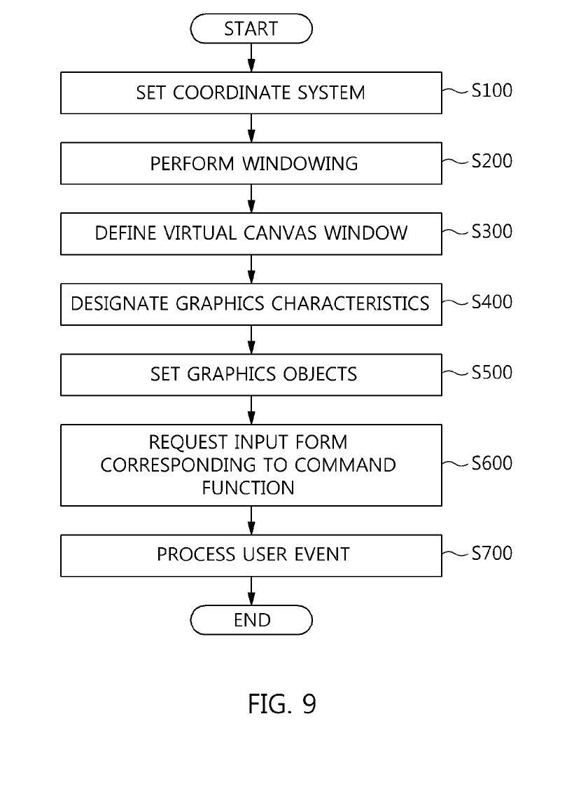

A method of providing graphic editors according to an embodiment of the present invention is described in detail with reference to FIG. 9.

FIG. 9 is a flowchart illustrating the method of providing graphic editors according to this embodiment of the present invention.

Referring to FIG. 9, the apparatus 300 for providing graphic editors sets a coordinate system required for the task of outputting a specific figure within a data structure onto a screen as a real-world coordinate system at step S100. The real-world coordinate system set at step S100 is an X-Y rectangular coordinate system, and has a range from − infinity to + infinity in each of X and Y axes. In general, however, if the real-world coordinate system is stored in memory within a computer and stored using 32-bit integer in the form of X and Y coordinates, the real-world coordinate system has a range of −2,147,483,648 to +2,147,483,648. Accordingly, in order to represent a figure within the data structure, stored as real-world coordinates, on a screen as a figure, there is a need for the task of converting the real-world coordinates into a screen or window coordinate system.

The apparatus 300 for providing graphic editors converts the figure within the data structure, stored as the real-world coordinate system set at step S100, into the coordinates of a screen or window coordinate system at step S200. A process of converting a figure within a data structure, stored as a real-world coordinate system, into coordinates of a screen or window coordinate system as at step S200 is called windowing. The windowing is a command that performs tasks, such as a zoom-in command, a zoom-out command, a pan command and a fit command.

The apparatus 300 for providing graphic editors defines a pair of one view region in a real-world coordinate system and a real physical window in which the view region is output onto a screen as a single virtual canvas window at step S300. In this case, the virtual canvas window is a virtual window that enables a figure to be drawn using real-world coordinates stored in a data structure without converting coordinates.

The apparatus 300 for providing graphic editors converts the coordinates of the virtual canvas window defined at step S300 into the coordinates of a window on an actual screen and designates graphics characteristics for an output task at step S400. At step S400, a figure can be drawn in the window on the screen using output-related functions provided by the Window System. In this case, the command function 341 of the output-related functions is required to convert the coordinates of the virtual canvas window into window coordinates on the screen.

At step S500, the apparatus 300 for providing graphic editors sets graphics objects corresponding to the data structure of the figures defined in order to draw a graphics figure in the virtual canvas window defined at step S300. In this case, the graphics object corresponds to a data format in which the type and characteristics of a figure to be output to the screen are delivered to the virtual canvas window.

The apparatus 300 for providing graphic editors receives an input request from the command function 341 and receives input data, corresponding to the input request, from the outside at step S600. In this case, the apparatus 300 for providing graphic editors receives the external input via one input source selected from among a mouse, a keyboard, and text.

At step S700, the apparatus 300 for providing graphic editors processes an event corresponding to the input data received from a user at step S600. That is, the apparatus 300 for providing graphic editors provides a graphic editor so that an event corresponding to the input data is processed using the graphics characteristics and the graphics object.

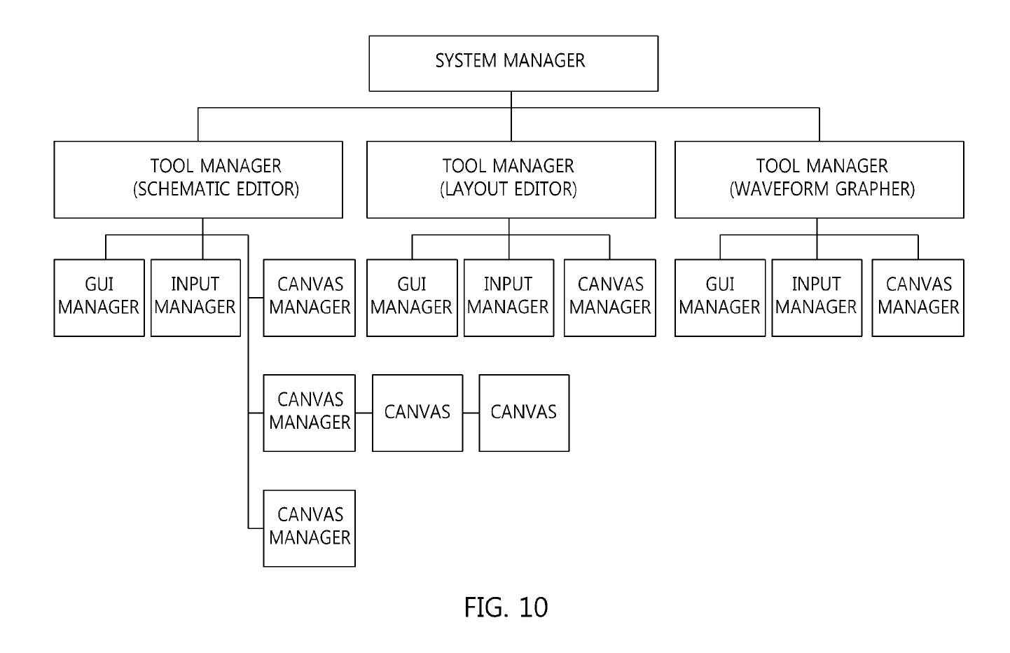

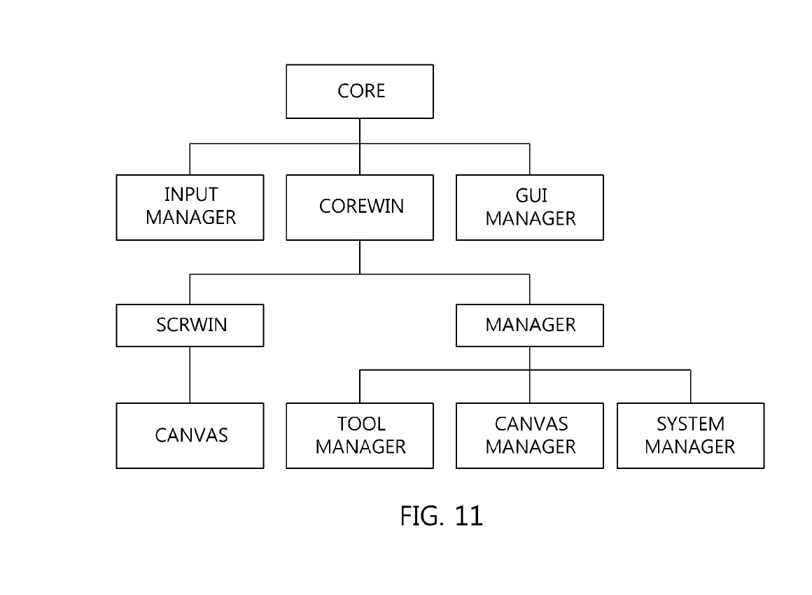

The structure of an apparatus for providing graphic editors according to an embodiment of the present invention is described in detail below with reference to FIG. 10.

FIG. 10 is a diagram illustrating the structure of the apparatus for providing graphic editors according to this embodiment of the present invention.

Referring to FIG. 10, the apparatus for providing graphic editors has a hierarchical structure including objects that perform respective functions.

A graphic editor using the apparatus for providing graphic editors includes a GUI manager, an input manager, and one or more canvas managers.

The GUI manager generates and controls the GUI window 100 having basic specifications which is provided by the apparatus for providing graphic editors.

The input manager delivers the input events of external inputs to the command function 341.

The canvas manager manages a canvas window to which a figure has been output.

The output of a figure is performed on the canvas manager. One canvas manager corresponds to one window in the X window, and one window is generated on a screen whenever one canvas manager is generated.

The canvas manager may draw a figure in real-world coordinates, and is different from a GUI manager and an input manager in that it includes a coordinate conversion function.

Figures having the same data structure may be edited by multiple canvas managers at the same time. For this purpose, the canvas manager manages a series of canvas objects that represent the same data.

A tool manager controls the three types of objects so that they operate in one graphic editor, and manages the three types of objects so that data is exchanged between them.

The apparatus for providing graphic editors provides a basic frame so that graphic editors having different functions and referring to the same data structure may be implemented in a single program. Accordingly, multiple tool managers may be present in a single program, as illustrated in FIG. 10. Referring to FIG. 10, multiple tool managers are managed by a system manager.

The system manager functions to manage multiple tool managers, initializes a Motif tool kit, and generates a color map, a fill pattern and fonts required for a graphics task so that the color map, a fill pattern and fonts are used in the output of a figure.

Next, the class structure of the apparatus for providing graphic editors is described in detail below with reference to FIG. 11.

FIG. 11 is a diagram illustrating the class structure of an apparatus for providing graphic editors according to an embodiment of the present invention.

The apparatus for providing graphic editors has been implemented based on an object-oriented programming concept.

In this embodiment of the present invention, each of multiple objects that form the apparatus for providing graphic editors is defined as a single class, and a collection of classes that belong to the classes and also have similar functions and characteristics is defined as a superclass. This process is repeated until all classes become the subclasses of a single class, thereby completing a hierarchical class structure, such as that of FIG. 11.

Referring to FIG. 11, objects at the bottom of a hierarchical class structure tree are objects actually used in the apparatus for providing graphic editors, and classes in the middle of the tree are middle classes generated to share functions and data between the classes.

A core class CORE is the highest superclass of all the classes, and functions to generate, initialize, implement and eliminate objects.

A class COREWIN provides the function of drawing a figure.

A class SCRWIN generates a window configured to fetch the functions of a Motif tool kit and then draw a figure when the class is generated as an object having a one-to-one correspondence with a window that is actually generated in an X Window System.

A manager class MANAGER has the function of managing other objects, and includes subclasses, such as the tool manager, the canvas manager and the system manager having an object of managing other objects.

In a hierarchical structure, such as that of FIG. 11, all the functions and characteristics of a superclass are handed down to a subclass. Accordingly, the overall size of a program can be reduced because one or more common characteristics and functions that are required for multiple classes are defined and implemented in only a single superclass, and a program can be easily reused because a new class can be defined by adding a characteristic required for the characteristics of a current class.

As described above, according to at least one embodiment of the present invention, the apparatus and method for providing graphic editors can reduce time and cost because many functions related to graphics and a user interface have been basically implemented in the apparatus for providing graphic editors upon providing a graphic editor.

Furthermore, the apparatus and method for providing graphic editors provides a graphic editor using the apparatus for providing graphic editors, so that a beginner who does not have experience related to the implementation of a GUI can easily provide a graphic editor in the desired application field. In particular, although a window graphics environment is changed, all graphic editors can be easily ported to a new environment even without modifying the graphic editors only if the apparatus for providing graphic editors is modified. Furthermore, the apparatus for providing graphic editors can represent one object, that is, an object of editing, in different windows from various viewpoints because it provides a multi-window environment. That is, a schematic diagram of a single electronic circuit and its layout can be represented on a screen at the same time, and the correlation between the schematic diagram and the layout can also be easily displayed.

The results of various types of graphic editors provided by the apparatus and method for providing graphic editors according to at least one embodiment of the present invention exhibit significant improvements in terms of ease of provision, provision time and maintenance.

For example, a schematic editor is a graphic editor for drawing and editing symbols, connection lines, and input and output terminals in order to design a logic circuit diagram and providing functions, such as the movement of a window. The schematic editor has been improved and developed several times in response to a change in a standard graphics environment. The length of code of the schematic editor has reduced to 22,300 lines in the CGI graphics environment of a SUN workstation, 19,400 lines in a SunView graphics environment, and 11,800 lines in an X window environment using the apparatus for providing graphic editors. The 14,000-line program of the apparatus for providing graphic editors can be reused without being modified. Accordingly, the length of code that needs to be provided by an application programmer has been reduced by half as compared with a case where the apparatus for providing graphic editors is used.

Furthermore, a design flow manager, that is, a tool for representing the flow of a specific design method as a figure via a GUI, providing guidance for the sequence of use, and automatically fetching a corresponding tool by selecting a button, has been provided as an example. Only one day was sufficient to edit lines, rectangles, and text with the help of various rubberbands and to implement the function of editing text and image buttons and the function of storing a received figure as a text file using the apparatus for providing graphic editors.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing graphic editors, comprising:
setting, by an apparatus for providing graphic editors, a coordinate system, which will be applied to a task of outputting one or more figures within a data structure onto a screen, as a real-world coordinate system;
converting the figures within the data structure, stored in the real-world coordinate system, into coordinates of a window coordinate system;
defining a pair of one view region in the real-world coordinate system and a real physical window in which the one view region is output onto a screen, as a single virtual canvas window;
converting the virtual canvas window into window coordinates on the screen using the window coordinate system, and designating graphics characteristics for an output task;
setting graphics objects corresponding to the data structure of the figures defined to draw a graphics figure in the virtual canvas window; and
providing a graphic editor so that an event corresponding to input data received from a user is processed using the graphics characteristics and the graphics objects.

2. The method of claim 1, wherein setting the coordinate system as the real-world coordinate system comprises setting the coordinate system as an X-Y rectangular coordinate system.

3. The method of claim 1, wherein converting the figures within the data structure into the coordinates of the window coordinate system comprises performing windowing adapted to execute tasks including a screen enlargement command, a screen reduction command, and a screen movement command.

4. The method of claim 1, wherein defining the virtual canvas window comprises defining a virtual window in which the figures are drawn using real real-world coordinates of the figures stored in the data structure without conversion of coordinates.

5. The method of claim 1, wherein designating the graphics characteristics comprises designating graphics characteristics corresponding to the figures so that the figures are finally drawn in a window on a screen using output-related functions provided by a Window System.

6. The method of claim 5, wherein a command function of the output-related functions corresponds to a function required to convert the coordinates of the virtual canvas window into the window coordinates on the screen.

7. An apparatus for providing graphic editors, comprising:
a coordinate system setting unit configured to set a coordinate system, which will be applied to the task of outputting figures within a data structure to a screen, as a real-world coordinate system;
a windowing unit configured to convert the figures within the data structure, stored in the real-world coordinate system, into coordinates of a window coordinate system;
a window definition unit configured to define a pair of one view region in the real-world coordinate system and a real physical window in which the one view region is output onto a screen as one virtual canvas window;
a window manager unit configured to convert coordinates of the virtual canvas window into window coordinates on the screen using the window coordinate system and to designate graphics characteristics for an output task;
a graphics object setting unit configured to set graphics objects corresponding to the data structure of the figures defined to draw a graphics figure in the virtual canvas window; and
an event processing unit configured to provide a graphic editor so that an event corresponding to input data received from a user is processed using the graphics characteristics and the graphics objects.

8. The apparatus of claim 7, wherein the coordinates setting unit sets the coordinate system as an X-Y rectangular coordinate system corresponding to the real-world coordinate system.

9. The apparatus of claim 7, wherein the windowing unit converts the figures into coordinates of the window coordinate system through windowing adapted to execute tasks including a screen enlargement command, a screen reduction command, and a screen movement command.

10. The apparatus of claim 7, wherein the window definition unit defines a virtual window in which the figures are drawn using real-world coordinates of the figures stored in the data structure without conversion of coordinates.

11. The apparatus of claim 7, wherein the window manager unit designates graphics characteristics corresponding to the figures so that the figures are finally drawn in a window on a screen using output-related functions provided by a Window System.

12. The apparatus of claim 11, wherein a command function of the output-related functions corresponds to a function required to convert the coordinates of the virtual canvas window into the window coordinates on the screen.
